(19) United States
(12) Patent Application Publication
(10) Pub. No.: US 2005/0218547 A1
(43) Pub. Date: Oct. 6, 2005

(54) Method for constructing composite moulded parts

(75) Inventors: Peter Roche, Emmering (DE); Thomas Bartz, Wiedenzhausen (DE); Erhard Guenther, Hassloch (DE); Urs Althaus, Uetendorf (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft

(21) Appl. No.: 10/504,640

(22) PCT Filed: Feb. 6, 2003
(86) PCT No.: PCT/EP03/01159

§ 371 Date: Aug. 12, 2004

(30) Foreign Application Priority Data
Feb. 27, 2002 (DE) 102 08 360.6

(51) Int. Cl. B29C 44/12

(52) U.S. Cl. 264/45.1; 264/172.19

(57) ABSTRACT

The present invention relates to a process for constructing a composite molding in which a support, a decorative part, and a foam coating are present, which comprises the following steps: 1. providing a mold with a sealable mold cavity, 2. providing a shaping support made from a material A, where A encompasses wood, metal, alloys, and thermoplastics, 3. providing a separable decorative part made from a material B, encompassing leather, textile, film or foil, paper, microfiber, or a combination of two or more of the materials mentioned, where the material has a frontal side which extends over a surface of the mold cavity, and an unencumbered reverse side, 4. placing the support into the mold, 5. spraying a coating made from foam-formers over the reverse side of the support, while the decorative part is in the mold cavity, 6. completing the reaction of the foam-formers, 7. closing the mold cavity and bringing the support sprayed with foam-formers into contact with the decorative part, and finally 8. demolding the composite molding.

The present invention relates to a process for laminating a foam to a decorative part which has a frontal side and a reverse side, where
a first operation spreads foam-formers on a surface,
a second operation permits reaction of the foam-formers to give a foam, and
a third operation brings the surface of the foam into contact with the reverse side of the decorative part when expansion of the foam ends.

In particular, the present invention relates to a process for constructng a composite molding in which a support, a decorative part, and a foam coating are present, which comprises the following steps:
1. providing a mold with a sealable mold cavity,
2. providing a shaping support made from a material A, where A encompasses wood, metal, alloys, and/or thermoplastics,
3. providing a separable decorative part made from a material B, encompassing leather, textile, film or foil, paper, microfiber, or a combination of two or more of the materials mentioned, where the material has a frontal side which extends over a surface of the mold cavity, and an unencumbered reverse side,
4. placing the support into the mold,
5. spraying a coating made from foam-formers over the reverse side of the support, while the decorative part is in the mold cavity,
6. completing the reaction of the foam-formers,
7. closing the mold cavity and bringing the support sprayed with foam-formers into contact with the decorative part, and finally
8. demolding the composite molding.

Composite moldings produced by bonding two or more materials nowadays play a major part in commerce, for example in the automotive industry. Two or more materials are bonded here to give a molding, utilizing the various properties of the different materials. To give an example, the metallic outer surface of automotive doors is smooth, paintable, and water-repellent, whereas if only for aesthetic reasons customers do not wish to see metal surfaces in the interior of the automobile, preferring leather with a decorative appearance, for example. Leather surfaces are also used in other locations in automobiles, in particular in high-price-group automobiles, examples being dashboards, center consoles, visors, and grips. Examples of other composite moldings are found in the furniture industry and in suitcases.

Quality features important for the customer here are not only the appearance but also the impression gained on touch, which should be very pleasant: this being known as “soft touch”.

One way of bonding the two materials here to one another is to introduce a foam between them, for example a polyurethane foam. There is an important problem with the bonding of the materials. The various materials can be bonded to one another by adhesives, such as hot-melt adhesives, but for many applications this is not an ideal method.

One particularly important method for bonding materials to give composite moldings of particular mechanical stability is back-foaming. Processes known from the prior art, for example from U.S. Pat. No. 5,296,182, for producing composite moldings, in which one material is leather, textile, paper, microfiber, or a mixture of these, usually start from a mold into which the leather, which may be taken as a representative of the abovementioned materials, is fitted. At the same time, another material is fitted into the mold in such a way that a cavity remains between the two materials—leather and second material. A spray gun, for example, is then used to inject a mixture of diisocyanate and polyol into this cavity. Reaction of polyol and diisocyanate forms a polyurethane foam which, because it requires considerably more space, automatically presses the leather and second material onto the mold and at the same time becomes reactively bonded to the leather, the foam therefore serving simultaneously as adhesive. This gives composite moldings with particularly good mutual bonding. However, a disadvantage is that measurable amounts of low-molecular-weight polyurethanes or diisocyanates or polyols penetrate through the pores of materials such as leather and textile, and form aesthetically unpleasant blemishes on the decorative leather. This formation of blemishes is even more marked when seamed leather is used.

U.S. Pat. No. 5,296,182 attempts to counter this problem by chemical modification of the barrier layer (column 7, line 41 et seq.). However, a coating is not generally a satisfactory solution, since it reduces the adhesion of the polyurethane foam to the leather layer. In addition, a further operation is needed.

U.S. Pat. No. 5,273,698 discloses a process for producing composite moldings in which polyol and diisocyanate are injected onto a leather or a fabric. Once the foam has formed, a solid, shaping support is pressed onto the almost completely reacted polyurethane foam. The process is particularly easy to carry out and is versatile with respect to shaping and materials. In addition, there is no need for extreme conditions of temperature or pressure, and there is little toxic gas discharge.

However, in particular when seamed leather parts are used, there is a high level of formation of blemishes.

EP-B 0 639 440 also discloses a process in which isocyanate and polyols are sprayed onto a thermoplastic backing fitted to a mold. The backings proposed comprise PVC, thermoplastic polyurethanes, thermoplastic olefins, and polyesters. In the final step, the expanding polyurethane foam is pressed against a hard support, examples of the support being steel, aluminum, polycarbonate, acrylonitrile-butadiene-styrene terpolymers, and styrene-maleic anhydride copolymers.

Although the process disclosed can reduce penetration of liquids into polyurethane if the use of leather is avoided, the process disclosed cannot solve the problem of the formation of blemishes on leather in composite moldings, since leather has particular aesthetic qualities.

It is an object of the present invention, therefore, to provide a process for constructing a composite molding in which a porous material is present as decorative layer, with no tendency toward formation of polyurethane blemishes on the leather.

We have found that this object is achieved by means of the process defined at the outset.

The support is usually composed of a material A. A encompasses wood, and also metals, such as steel, aluminum, and iron, metallic alloys being termed metals hereinafter. Material A also encompasses polymeric support materials. Suitable materials are thermoplastic polyols, such as polyolefins, e.g. polyethylene and polypropylene, and also copolymers of these, and moreover polyesters, such as polyethylene terephthalate PET, polybutylene terephthalate PBT, and moreover polycycloolefins, poly(meth)acrylates, such as polymethyl methacrylate, polyamides, polycarbonates, polyurethanes, polyacetals, such as polyoxymethylene POM, polystyrenes, polyphenylene ethers, polysulfones, polyether sulfones, polyether ketones, polyketones, styrene (co)polymers, and also blends of the above polymers.

Suitable styrene (co)polymers are acrylonitrile-butadiene-styrene graft copolymers ABS, acrylonitrile-styrene-acrylonitrile graft copolymers ASA, such as the commercial product Luran® S from BASF Aktiengesellschaft. Other suitable styrene (co)polymers are styrene-acrylonitrile copolymers SAN, methyl methacrylate-acrylonitrile-butadiene-styrene copolymers, such as the commercially available product Terlux® from BASF Aktiengesellschaft, mixtures of different styrene-butadiene copolymers, styrene-butadiene block copolymers, vinyl chloride-acrylate graft copolymers, and finally styrene-maleic anhydride copolymers, such as Dylark® trademarks.

The support is preferably composed of polypropylene, polyamides, polybutylene terephthalate, crosslinked foamed polyurethanes, thermoplastic polyurethanes, polycarbonates, ASA, or ABS, or a mixture of these. Examples of preferred polymer mixtures comprise polycarbonate, polybutylene terephthalate, or polycarbonate and ABS, polycarbonate and ASA, e.g. Bayblend®, or polybutylene terephthalate and ASA, e.g. Ultradur® from BASF Aktiengesellschaft. In preparing the polymer mixtures it is also possible, of course, to use recycled materials made from the abovementioned thermoplastic polymers.

For the purposes of the present invention, polypropylene is propylene homopolymers and also copolymers of propylene which alongside propylene contain copolymerizable monomers, such as ethylene or C₄-C₈ olefins, such as 1-butene, 1-pentene, 1-hexene, or 1-octene.

Based on the total weight of support material, polymeric supports may comprise from 1 to 60% by weight, preferably from 5 to 50% by weight, of conventional auxiliaries, fillers, or fiber materials.

Examples of these auxiliaries are lubricants, mold-release agents, waxes, colorants, special-effect colorants, flame retardants, antioxidants, and stabilizers, for example to counter exposure to light or heat, and antistats.

Particulate fillers which may also be used are carbon black, wood flour, amorphous silica gels, magnesium carbonate, magnesium hydroxide, magnesium oxide, barium sulfate, aluminum oxide, powdered quartz, mica, bentonite, talc, in particular with an average particle size in the range from 0.1 to 10 μm measured to DIN 6615, calcium carbonate, chalk, glass beads, feldspar, or in particular calcium silicates, such as wollastonite, or kaolin.

It is also possible to use fibrous materials in the support, and for the purpose of the present invention these include platy materials, examples being jute, hemp, flax, sisal, ramie, carnauba, aluminum flakes, aramid fibers, steel fibers, carbon fibers, and glass fibers, including those coated with a size.

Instead of a support, use may be made of a means of release which prevents firm adhesion of the foam to the mold. Preferred means of release is a release film or a mold-release film, in particular made from polyethylene.

For the purposes of the present invention, polyethylenes are ethylene homopolymers, but preferably copolymers of ethylene which alongside ethylene contain copolymerizable monomers, such as C₃-C₈ olefins, e.g. propylene, 1-butene, 1-pentene, 1-hexene, or 1-octene.

The decorative part may be composed of a very wide variety of types of material B. B encompasses leather, which may be tanned with or without the use of chromium compounds, preference being given to leathers tanned without the use of chromium, and these may be finished, i.e. coated, or as yet uncoated (what is known as crust leather). B also encompasses textiles made from natural or synthetic fibers, and in particular encompasses microfibers or mixtures, the type of weave here being non-critical, and also nonwovens and knits. B also encompasses paper, the stiffness and shape of which is non-critical. Alcantara may be mentioned as examples of the preferred microfibers.

Finally, for the purposes of the present invention B also encompasses mixtures of two or more of the abovementioned materials, for example seamed or jointed combinations of textile and leather or leather and microfiber.

The decorative part provided may be a preformed shell.

For the purposes of the present invention, the foam coating is composed of foam known per se, and for the purposes of the present invention foam is a polymer foam, generally formed from a foamable polymer crosslinked to give a wide-mesh material. Preference is given to polyurethane foam, polyurea-formaldehyde foams, melamine-formaldehyde foams, and thermoplastic foams, such as physically blown polypropylene, e.g. Neopolen®, or polyethylene. Polyurethane foam is very particularly preferred.

Polyurea-formaldehyde foams may be obtained by mixing commercially available urea-formaldehyde solutions of strengths from 30 to 40% by weight with a hardener, such as aqueous phosphoric acid. Polyurea-formaldehyde foams and their preparation are described in Ullmann's Encyclopedia of Industrial Chemistry, Volume A11, p. 452, 5^{th} Edition, (1990), Verlag Chemie Weinheim, and in the references cited therein.

Melamine-formaldehyde foams, such as the product Basotect® marketed by BASF Aktiengesellschaft, may advantageously be obtained by mixing melamine-formaldehyde resins (melamine:formaldehyde molar ratio about 1:3), for example in the form of an emulsion in pentane, with an acid, such as formic acid. Melamine-formaldehyde foams and their preparation are described in Ullmann's Encyclopedia of Industrial Chemistry, Volume A11, p. 453, 5^{th} Edition, (1990), Verlag Chemie Weinheim, and in the references cited therein.

The foam selected for coating is preferably a polyurethane foam. Polyurethane foams are composed of polyisocyanate polyaddition products. For the purposes of the present invention, the expression “polyisocyanate polyaddition products” means polyisocyanurates, polyureas, and in particular polyurethanes, which, where appropriate, may contain urea structures. Preference is given here to polyisocyanate polyaddition products based on
(a) isocyanates,
(b) compounds reactive toward isocyanates, and also, where appropriate,
(c) catalysts, and, where appropriate,
(d) auxiliaries.

Polyurethane foams are produced from isocyanates (a) and compounds (b) reactive toward isocyanates, in particular polyols. They are preferably produced in the presence of a catalyst. The isocyanates (a) used comprise well known (cyclo)aliphatic and/or in particular aromatic di- and polyisocyanates. (cyclo)aliphatic diisocyanates are in particular alkylene diisocyanates having from 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates, such as cyclohexane 1,3- and 1,4-diisocyanate, and also any desired mixtures of these isomers, 1-isocyanato-3,3,5-trimethyl-5-isocyanatomethylcyclohexane (isophorone diisocyanate), hexahydrotolylene 2,4- and 2,6-diisocyanate, and also the corresponding isomer mixtures, dicyclohexylmethane 4,4′-, 2,2′-, and 2,4′-diisocyanate, and also the corresponding isomer mixtures. Examples of aromatic diisocyanates are tolylene 2,4- and 2,6-diisocyanate and the corresponding isomer mixtures, diphenylmethane 4,4′-, 2,4′-, and 2,2′-diisocyanate, and the corresponding isomer mixtures, and mixtures of diphenylmethane 4,4′- and 2,4′-diisocyanates, other examples are polyphenyl polymethylene polyisocyanates and mixtures of diphenylmethane 4,4′-, 2,4′-, and 2,2′-diisocyanates with polyphenyl polymethylene polyisocyanates (crude MDI) and mixtures of crude MDI with tolylene diisocyanates. Preferred examples are diphenylmethane diisocyanate (MDI) and tolylene diisocyanate (TDI). The isocyanates may be used in the form of the pure compound or in modified form, for example in the form of uretdiones, isocyanurates, allophanates, or biurets, preferably in the form of reaction products containing urethane groups and isocyanate groups and known as isocyanate prepolymers.

The compounds (b) used which are reactive toward isocyanates are polyols, such as polyether polyols, or other diols, or, as crosslinkers, triols. These polyols are well known and commercially available and selected, for example, from diols, such as ethylene glycol, propylene glycol, 1,4-butanediol, 1,5-pentanediol, 1,6-hexanediol, and other aliphatic diols. Other useful polyols are based, for example, on conventional starter compounds which are reacted with conventional alkylene oxides, such as propylene oxide and/or ethylene oxide, under well known conditions. The crosslinkers are compounds with molecular weights of from 60 to 499 and with three or more active hydrogen atoms, preferably amines, and particularly preferably alcohols, such as glycerol, trimethylolpropane, pentaerythritol, or diethanolamine. The catalysts (c) used may be conventional compounds which markedly accelerate the reaction of the components, for example. Examples of those which may be used are tertiary amines and/or organometallic compounds, in particular tin compounds. The catalysts whose use is preferred are those which cause minimum fogging, i.e. minimum emission of volatile compounds from the reaction product (ii), for example tertiary amines having reactive end groups and/or relatively high-boiling amine catalysts. Examples of compounds which may be used as catalysts are the following: triethylenediamine, aminoalkyl- and/or aminophenylimidazoles, e.g. 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole, and/or 1-(3-aminopropyl)-2-methylimidazole, stannous salts of organic carboxylic acids, e.g. stannous diacetate, stannous dioctoate, stannous diethylhexoate, and stannous dilaurate, and dialkyl tin(IV) salts of organic carboxylic acids, e.g. dibutyltin diacetate, dibutyltin dilaurate, dibutyltin maleate, and dioctyltin diacetate.

Blowing agents which may be used for producing foamed products are well-known compounds with chemical or physical action. Water is the preferred blowing agent used with chemical action, and forms carbon dioxide via reaction with the isocyanate groups. Examples of physical blowing agents, i.e. intrinsically inert compounds which evaporate under the conditions of polyurethane formation, are (cyclo)aliphatic hydrocarbons, preferably those having from 4 to 8, particularly preferably from 4 to 6, and in particular 5, carbon atoms, partially halogenated hydrocarbons and ethers, ketones, and acetates. The amount used of the blowing agents depends on the desired density of the foams. The various blowing agents may be used individually or in any desired mixture with one another. It is particularly preferable to use water alone as blowing agent. The amount preferably used as physical blowing agents is <0.5% by weight, based on the weight of the component.

Where appropriate, the reaction takes place in the presence of auxiliaries (d) e.g. fillers, cell regulators, surface-active compounds, and/or stabilizers to inhibit oxidation, or thermal or microbial degradation or aging.

The substances forming polyurethane foam are usually substances which operate by the prepolymer process.

In the prepolymer process known per se, a first step usually prepares a prepolymer containing isocyanate groups from diisocyanate and a substoichiometric amount of polyol, and the prepolymer can then be used for reaction with further polyol to give the desired products.

Very particularly suitable systems are those obtainable commercially from the company Elastogran GmbH: Elastocoat® C, Elastoflex® E, Elastoflex® W and Elastofoam®.

The compounds (b) used which are reactive toward isocyanate are preferably those which bear at least one primary and/or secondary amino group. In the particularly preferred embodiment in which the isocyanates (a) and the compounds (b) of the invention which are reactive toward isocyanates are not mixed together until very briefly prior to spray-application, preferably not earlier than 30 s, particularly preferably not earlier than 10 s, prior to application to the reverse side of the support, it is possible to obtain a particularly finely divided atomized spray which firstly can achieve particularly thin coatings and secondly ensures uniform distribution of the polyurethane foam.

The density of the foam coating, determined to DIN 53420, is from 20 to 800 g/l, preferably from 40 to 400 g/l. In another embodiment, the density of the foam coating is from 800 to 1800 g/l, preferably from 1000 to 1200 g/l.

The invention is illustrated using the diagrams 1a to 1b, these drawings representing one embodiment but not intended to be understood as limiting. Drawing 1a shows one embodiment of the opened mold F.

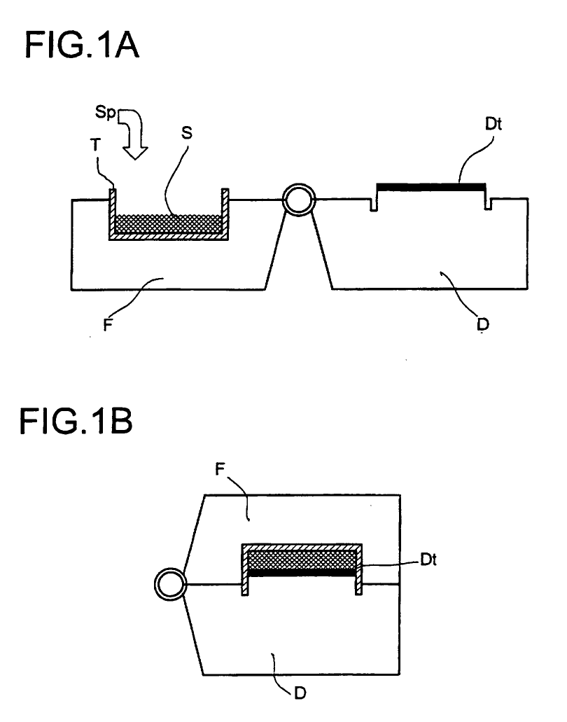

The mold F with a sealable mold cavity is first provided. The size of the mold and its material are non-critical here. For example, use may be made of molds depicted in EP-B 0 639 440, FIGS. 1-4. It is preferable that the mold cavity be sealable using a cover D to which the decorative part has been secured.

A shaping support T made from a material A is also provided, A being as defined above. The support T serves for the shaping of the composite, and may have the shape of a component, for example. It may therefore be a part of the automobile, for example a part of the automobile frame or an automobile door, and grip preforms are also suitable. Examples of other suitable products are the housings of mobile telephones and a wide variety of parts in the furniture sector, and also shells and grips for suitcases. For the purposes of the present invention, that side of the support which on the finished composite molding is not visible and onto which the foam-forming materials are sprayed during the further course of the process is the reverse side of the support.

The removable decorative part described above, Dt, is also provided and is composed of the material B. The decorative part Dt is secured in the mold cavity, for example using commercially available pressure-sensitive adhesives, or by applying a vacuum, preferably of from 100 to 500 mbar.

The decorative part Dt may also have been shaped. This shape has been adapted to subsequent use, for example as an armrest for a seat, an automobile door, a dashboard for an automobile, an instrument panel, or the housing of a mobile telephone. For the purposes of the present invention, that side of the decorative part Dt which is subsequently not visible is termed the reverse side of the decorative part Dt.

The support T is placed in the mold F, and this step may be carried out manually or may be an automated step. It is preferably automated. To improve operating precision, the support T is secured in the mold F, and any desired methods known per se may be used for this securing process, for example a manual method or one using studs, clamps, commercially available pressure-sensitive adhesives, or application of a vacuum.

In one preferred embodiment of the present invention, the location of the decorative part is below that of the support. In another embodiment of the present invention, support and decorative part are arranged alongside one another.

If the desire is to dispense entirely with any support T and instead to apply a layer of a means of release, then in one preferred embodiment of the present invention the arrangement has the decorative part Dt below the means of release. In another embodiment of the present invention, the means of release and the decorative part Dt are arranged alongside one another.

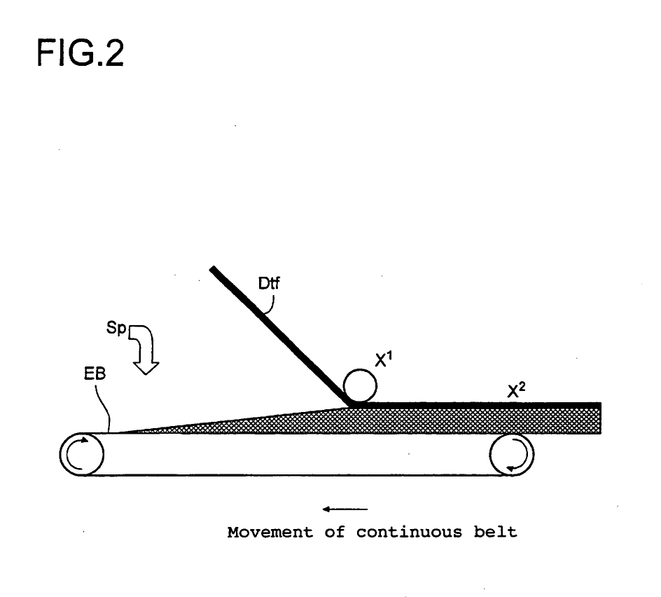

Spray equipment Sp is then used to spray a coating made from foam-formers over the reverse side of the support T. There are various possible procedures for the spraying process. It is usual to use a spray gun which has an integrated mixing head and which is operated manually or else automatically, preferably automatically. Spray equipment of this type is known per se and is commercially available, and is illustrated diagrammatically by way of example in FIG. 2 of EP-B 0 639 440.

If the desire is to produce a polyurethane foam, the amounts reacted of the isocyanate groups and the groups reactive toward isocyanates when carrying out the process of the invention are such that the ratio of equivalents of NCO groups to the total of the reactive hydrogen atoms is preferably from 0.95 to 1.3:1, particularly preferably from 1 to 1.2:1, and in particular from 1 to 1.15:1. If the product contains at least some isocyanurate groups, the ratio usually used of NCO groups to the total of the reactive hydrogen atoms is from 1.5 to 60:1, preferably from 1.5 to 8:1.

It is preferable for components a) and b) not to be brought into contact until they have reached the mixing head of the spray equipment.

It is preferable for components (c) and (d) to be mixed with the component (b) reactive toward isocyanate prior to use of the material. However, it is also possible to mix component (c) or (d) with the isocyanate (a) prior to the reaction. It is also possible for components (c) and (d) to be mixed with the isocyanate (a) prior to the reaction.

The spraying of the reverse side of the support T with the foam-formers coats the support, and the foam-forming reaction begins. The support T may be coated uniformly with a constant thickness of the foam-forming materials. However, there may also be local variations in the thickness of coating applied to the support. This embodiment of the present invention is useful especially when the decorative part Dt or the support T, or both, have curvature. The thickness of the coating is usually from 0.2 to 50 mm, measured after foam-formation has ended.

The substances used in the process of the invention and which form the foam S, for example the polyurethane-foam-formers, usually react in such a way that the foam S increases in volume with time. For the purposes of the present invention, this time is termed the full rise time. Once the volume of the foam remains constant, the end of the expansion time or full rise time for the foam has been reached.

The end of the full rise time for a particular foam can readily be determined by the skilled worker, and is advantageously determined with the foam-formers intended for use before carrying out the process of the invention. As is known from the literature, one of the ways of influencing the full rise time is via the selection of components (a) to (d) and the quantitative proportion of each.

According to the invention, the decorative part Dt is brought into contact with the foam S within a period, starting from the end of the coating process, of up to four times, preferably from half to twice, the total rise time for the foam, and particularly preferably at the end of the full rise time. The decorative part Dt is advantageously brought into contact with the foam by closing the mold cavity. This bonds the decorative part Dt and the foam S together, and assistance here may be obtained by operating with an increased pressure.

Drawing 1b shows one embodiment of the closed mold F.

After a dwell time in the mold, which is usually a few minutes, for example from 2 to 5 minutes, but is not critical per se, a further step removes the composite molding, i.e. takes it from the mold. The abovementioned cycle is then repeated.

The composite moldings produced by the process of the invention have particularly good mechanical properties. For example, the composite moldings produced according to the invention preferably have densities of from 500 to 1250 kg/m³, tensile strength to DIN EN 61 of from 40 to 200 MPa, tensile modulus of elasticity to ISO 527-2 of from 2500 to 10000 MPa, and impact strength to ISO 179 of from 15 to 200 kJ/m². Both the decorative part and the support have frontal sides which are free from blemishes. In addition, decorative parts made from leather have a very pleasant “soft touch”, and are free from wrinkling.

The process of the invention may be carried out batchwise, as described above.

Another aspect of the present invention is a continuous version of the inventive process described above. For this, the procedure according to the invention is as follows:
1. a continuous belt is provided,
2. a decorative part in the form of a film made from a material B is provided,
3. a coating made from foam-formers is sprayed onto the continuous belt,
4. complete reaction of the foam-formers is permitted, during which the belt is advanced,
5. an apparatus is used to bring the decorative part into contact with the foam, and
6. the resultant composite molding is removed.

The diagram in drawing 2 illustrates one embodiment of the continuous version of the process of the invention.

The detailed procedure for working the continuous version of the process of the invention is that a continuous belt EB is provided and, where appropriate, is provided with a means of release. This means of release may be composed of a release coating, in particular of a release film, which is preferably composed of polyethylene. A decorative part Dtf taking the form of a film is also provided and is fed by way of rollers onto the continuous belt, and is composed of the material B, B being as defined above.

Spray equipment Sp is used to spray a coating made from foam-formers onto the continuous belt EB, the manner of selection of the foam-formers being as in the batchwise version. The foam-formers are then permitted to react to completion, while the belt is advanced at a constant rate.

The substances used in the process of the invention and which form the foam S, for example the polyurethane-foam-formers, usually react in such a way that the foam S increases in volume with time. For the purposes of the present invention, this time is termed the full rise time. Once the volume of the foam remains constant, the end of the expansion time for the foam, or the end of the full rise time, has been reached.

The end of the full rise time for a particular foam can readily be determined by the skilled worker, and is advantageously determined with the foam-formers intended for use before carrying out the process of the invention. As is known from the literature, one of the ways of influencing the full rise time is via the selection of components (a) to (d) and the quantitative proportion of each. A calculation using the rate at which the belt is moving can determine the position which the belt has reached when the full rise time ends, given that the continuous belt and the spray equipment are in steady-state operation.

According to the invention, the decorative part Dtf is brought into contact with the foam S during traverse between the spray equipment and a point at a distance which is four times that given by the position at which the full rise time ends.

It is preferable for the decorative part Dtf to be brought into contact with the foam S during traverse between points at half and twice the distance given by the position at which the full rise time ends. It is particularly preferable for the decorative part to be brought into contact with the foam S precisely at the position at which the full rise time ends.

Contact is advantageously brought about by an apparatus, for example a roller X¹. The decorative part Dt and foam S are thereby bonded to one another, and assistance may be obtained here by using an elevated pressure.

At the site X², the foam is released from the coated continuous belt and, where appropriate the retention of the release film is released, for example by peeling, or by ceasing to apply vacuum. This gives a long composite molding which can then be divided into relatively small pieces of desired dimensions, for example by sawing or stamping.

Another aspect of the present invention is the use of composite moldings produced by the process of the invention as internal trim parts for automobiles. Another aspect of the present invention is the use of composite moldings produced via the process of the invention for mobile telephones, furniture, or suitcases. The frontal sides of the decorative part, and of the support, are entirely free from blemishes. Decorative parts made from leather also have very pleasant “soft touch”, and are free from wrinkling.

Examples are used to illustrate the invention.

### EXAMPLES

1. Batchwise Process for Producing a Composite Molding

1.1.A decorative part made from nappa-type cattlehide leather tanned by a chromium-free method, uniform thickness from 1.0 to 1.2 mm, through-dyed and finished, with seams (lap seam and butt seam) in the form of a door panel for an automobile was placed into a mold cavity and secured by applying a vacuum of from 100 to 500 mbar. A conventional high-pressure spray machine, model PSM 3000 from the company Isotherm AG, was used to coat the support in the form of the appropriate automobile door panel made from ABS with the complete flexible-polyurethane-foam-former system Elastocoat® 66-001/BA, commercially available from Elastogran GmbH to a uniform thickness of 10 mm within a period of 50 seconds.

30 seconds after spraying had ended, foam expansion was complete. The mold was closed in such a way that the support was above the leather.

After a residence time of from 3 to 5 minutes, the finished composite molding could be demolded. The surface of the leather was free from blemishes and had a very pleasant “soft touch”. The composite molding also had uniform thickness and no voids.

1.2.A decorative part made from mixed polyamide/polyester in the form of a door panel for an automobile was placed into a mold cavity and secured by applying a vacuum of from 100 to 500 mbar. A conventional high-pressure spray machine model PSM 3000 from the company Isotherm AG was used to coat the support in the form of the appropriate automobile door panel made from ABS with the complete flexible-polyurethane-foam-former system Elastocoat® 66-001/BA, commercially available from Elastogran GmbH to a uniform thickness of 10 mm within a period of 50 seconds.

30 seconds after spraying had ended, foam expansion was complete. The mold was closed in such a way that the support was above the decorative part.

After from 3 to 5 minutes of residence time, the finished composite molding could be demolded. The surface of the mixed fabric had a uniform fabric structure and showed no polyurethane penetration.

1.3.A decorative part made from Alcantara (commercially available from Alcantara S.p.A.) in the form of a door panel for an automobile was placed into a mold cavity and secured by applying a vacuum of from 100 to 500 mbar. A conventional high-pressure spray machine, model PSM 3000 from the company Isotherm AG, was used to coat the support in the form of the appropriate automobile door panel made from ABS with the complete flexible-polyurethane-foam-former system Elastocoat® 66-001/BA, commercially available from Elastogran GmbH to a uniform thickness of 10 mm within a period of 50 seconds.

30 seconds after spraying had ended, foam expansion was complete. The mold was closed in such a way that the support was above the decorative part.

After from 3 to 5 minutes of residence time, the finished composite molding could be demolded. The surface of the mixed fabric had a uniform fabric structure and showed no polyurethane penetration. The Alcantara surface was free from blemishes and had particularly good “soft touch”.

### 1.4. COMPARATIVE EXAMPLE

Example 1.1 was repeated, but decorative part and support were swapped, and the decorative part was coated. After demolding, the leather was found to have hardened undesirably. In addition, polyurethane had penetrated the seams. Blemishes were apparent on the surface of the leather.

2. Continuous Process for Producing a Composite Molding

A continuous belt (total system length: 5 m, belt width: 40 cm) as in FIG. 1, which had been coated with polyethylene and was moving at 30 cm/s was coated with a thickness of 10 mm of polyurethane foam, with the aid of the spray machine from Example 1. The continuous belt sprayed with the foam-formers moved onward to encounter a roller and a leather strip of width 40 cm, composed of a leather as in Example 1.1. The leather strip was applied to the foam and pressed in place by the roller.

This gave a long composite molding which was easy to remove from the belt.

The surface of the leather had very good “soft touch” and was free from blemishes.

1-15. (canceled)

16. A process for constructing a composite molding in which a support, a decorative part, and a foam coating are present, which comprises:
providing a mold with a sealable mold cavity;
providing a shaping support made from a material A, where A encompasses wood, metal, alloys, and/or thermoplastics;
providing a separable decorative part made from a material B, encompassing leather, textile, film or foil, paper, microfiber, or a combination of two or more of the materials mentioned, where the material has a frontal side which extends over a surface of the mold cavity, and an unencumbered reverse side;
placing the support into the mold;
spraying a coating made from foam-formers over the reverse side of the support, while the decorative part is in the mold cavity;
completing the reaction of the foam-formers;
closing the mold cavity and bringing the support sprayed with foam-formers into contact with the decorative part; and finally
demolding the composite molding.

17. A process as claimed in claim 16, wherein, instead of a support, a means of release is used.

18. A process as claimed in claim 16, wherein the mold cavity is closed with the aid of a mold cover.

19. A process as claimed in claim 16, wherein the decorative part provided is a preformed shell.

20. A process as claimed in claim 16, wherein the foam is selected from the group consisting of a polyurethane foam, a polyurea-formaldehyde foam, a melamine-formaldehyde foam, a thermoplastic foam, and mixtures thereof.

21. A process as claimed in claim 20, wherein the foam coating comprises
at least one polyisocyanate polyaddition product obtained from at least one isocyanate;
at least one compound reactive toward at least one isocyanate;
optionally at least one catalyst; and
optionally at least one auxiliary.

22. A process as claimed in claim 21, wherein the compound reactive toward isocyanate is a compound which bears at least one primary or secondary amino group.

23. A process as claimed in claim 20, wherein the density of the foam coating is from 20 to 800 g/l or from 800 to 1800 g/l.

24. A process as claimed in claim 21, wherein at least one isocyanate and at least one compound reactive toward at least one isocyanate components do not contact one another until they reach the mixing head of the spray equipment.

25. A process as claimed in claim 16, wherein a constant thickness is used when coating the support.

26. A process as claimed in claim 16, wherein the thickness used when coating the support has local differences.

27. A process as claimed in claim 16, wherein the thickness of the coating is from 0.2 to 50 mm.

28. A continuous process for producing composite moldings comprising a foam coating and a decorative part, which comprises providing a continuous belt;
providing a decorative part in the form of a film made from a material B;
spraying a coating made from foam-formers onto the continuous belt;
permitting complete reaction of the foam-formers, during which the belt is advanced;
using an apparatus to bring the decorative part into contact with the foam; and
removing the resultant composite molding.

29. A composite molding produced by the process as claimed in claim 16, which is capable of internally trimming an automobile.

30. Internal automobile trim, which comprises:
the composite molding produced by the process as claimed in claim 16.

31. A mobile telephone, furniture, or suitcase comprising
at least one composite molding produced by a process as claimed in claim 16.
